(19) United States
(12) Patent Application Publication
(10) Pub. No.: US 2025/0273078 A1
(43) Pub. Date: Aug. 28, 2025

(54) METHOD FOR NEUROFEEDBACK TRAINING TO OUTPUT BRAIN-REGION REALITY

(71) Applicant: ExeBrain Co., Ltd., Taipei City (TW)

(72) Inventors: Shu-Chun Kuan, Taipei City (TW); Jason Chun-Cheng Lin, Taipei City (TW)

(21) Appl. No.: 18/829,386

(22) Filed: Sep. 10, 2024

(30) Foreign Application Priority Data
Feb. 27, 2024 (TW) 113107041

(51) Int. Cl. G09B 5/02; G06F 3/01

(52) U.S. Cl. CPC G09B 5/02; G06F 3/015

(57) ABSTRACT

A method for neurofeedback training to output brain-area reality is disclosed. The method includes transmitting a physical and mental parameter related to a subject as a neurophysiological signal; performing signal processing, feature extraction and pattern determination on the neurophysiological signal; providing a neurophysiological feedback parameter and conducting a brain region network activity; and converting a brain-area reality through a brain-computer interface to present an interactive scene and an interactive element to the subject for brain/brain-area (an Electroencephalography (EGG) brain waves and/or brain network) training. In this way, the subject's brain area training status can be known in real time and the subject can understand the state of his own brain area through visual means, so as to facilitate communication between subjects (or their family members or related persons) and professionals (such as doctors).

### CROSS-REFERENCE TO RELATED APPLICATIONS

This application claims the priority of Taiwanese patent application No. 113107041, filed on Feb. 27, 2024, which is incorporated herewith by reference.

### PRIOR ART

Existing biofeedback training mainly uses wireless devices at the input end, such as using a pair of electrode patches to compare brain wave changes before and after training in three areas of the parietal lobe. A pair of electrode patches is used to detect the impact of neurophysiological feedback on sensorimotor rhythm (SMR), or it collects physiological signals and uploads the physiological data to the cloud platform for analysis through wired or wireless transmission modules. The user needs to open the APP or related applications to retrospectively read the physiological device during sleep periods. However, existing technology usually prevents subjects from immediately obtaining physiologically relevant information such as brain waves or heartbeat variations, and they need to wait for hours to days for interpretation.

At the same time, although the existing smart bed health management system also collects physiological signals, what is collected is the physiological signals of individuals while sleeping in bed. Physiological signals are uploaded to the cloud platform for analysis through wired or wireless transmission modules. The user needs to open the relevant application to retrospectively read the physiological device during sleep periods. The disadvantage is that individual physiological signals cannot be immediately processed and fed back to the subject after being transmitted.

In addition, there is a feedback mechanism of functional magnetic resonance imaging (Real time fMRI neurofeedback), however, because magnetic resonance imaging equipment is quite expensive and is mostly installed in medical institutions, and the process of collecting signals and imaging takes more than 30 minutes, and the calculation of the feedback mechanism also takes more than 10 minutes, it is impossible to achieve remote configuration and real-time (in 1 Within minutes) analysis feedback. Moreover, even if feedback is obtained, the subject cannot understand which brain area needs training, and how to communicate with professionals (such as doctors), making it impossible to achieve remote and immediate feedback and training.

### BACKGROUND OF THE INVENTION

The present invention relates to the technical field of neurofeedback, in particular to a method for neurofeedback training to output brain-area reality.

### SUMMARY OF THE INVENTION

A primary objective of the present invention is to provide a method for neurofeedback training to output brain-area reality. It is a training brain-area reality APP. It transmits the relevant physical and mental parameters of the subject as neurophysiological signals, and performs signal processing, feature extraction and pattern determination to determine the neurophysiological feedback parameters and brain regional network activities through the brain-computer interface. It is transformed into a real-life environment to present interactive scenes and interactive elements for users to perform brain (area) training. In this way, the subject's brain area training status can be known in real time and the subject can understand the state of his own brain area through visual means, so as to facilitate the communication between the subject (or his family or related persons) and professionals (such as doctors). communication between.

A method for neurofeedback training to output brain-area reality includes transmitting a physical and mental parameter related to a subject as a neurophysiological signal; performing signal processing, feature extraction and pattern determination on the neurophysiological signal; providing a neurophysiological feedback parameter and performing a brain region network activity; and converting a brain-area reality through a brain-computer interface to present an interactive scene and an interactive element for the subject to perform an Electroencephalography (EGG) brain waves and/or brain network training

In some embodiments, the brain-area reality is realized by one of augmented reality, virtual reality, mixed reality and extended reality.

In some embodiments, the physical and mental parameters are collected through a brain wave collection device.

In some embodiments, the physical and mental parameters are receiving scalp EEG signals from one or more channel.

In some embodiments, the brainwave data includes amplitude, frequency, location and pattern characteristics.

In some embodiments, the brain-computer interface is a mobile communication device or a computer.

In some embodiments, the mobile communication device is a smartphone with an application including web-based applications, mobile applications, virtual reality, or video games.

In order to make the above objectives, features and advantages of the present invention more obvious and understandable, the specific embodiments listed in the drawings are described in detail below.

### BRIEF DESCRIPTION OF DRAWINGS

Aspects of the present invention are best understood from the following detailed description when read with the accompanying figures. It is noted that, in accordance with the standard practice in the industry, various features are not drawn to scale. In fact, the dimensions of the various features may be increased or reduced for clarity of discussion.

FIG. 1 is a flow chart of a method for neurofeedback training to output brain-area reality of the present invention.

FIG. 2 is a schematic diagram of a brainwave collection device used in the method for neurofeedback training to output brain-area reality according to the present invention.

FIG. 3 is a schematic side view of the brainwave collection device used in the method for neurofeedback training to output brain-area reality according to the present invention.

FIG. 4 is a schematic diagram of brainwave feature analysis of the method for neurofeedback training to output brain-area reality according to the present invention.

FIG. 5 is a schematic diagram of the brain reality interaction scene of the method for neurofeedback training to output brain-area reality according to the present invention.

FIG. 6 is a schematic diagram of the method for neurofeedback training to output brain-area reality according to the present invention, which is implemented by the brain through augmented reality.

### DETAILED DESCRIPTION OF THE INVENTION

It will be appreciated that, although specific embodiments of the present invention are described herein for purposes of illustration, various modifications may be made without departing from the spirit and scope of the present invention.

In the following description, certain specific details are set forth in order to provide a thorough understanding of various aspects of the disclosed subject matter. However, the disclosed subject matter may be practiced without these specific details. In some instances, well-known structures and methods of power delivery comprising embodiments of the subject matter disclosed herein have not been described in detail to avoid obscuring the descriptions of other aspects of the present invention.

Unless the context requires otherwise, throughout the specification and claims that follow, the word “comprise,” “have,” “include,” and variations thereof, such as “comprises,” “comprising,” “having,” “including” are to be construed in an open, inclusive sense, that is, as “including, but not limited to.”

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the particular features, structures, or characteristics may be combined in any suitable manner in one or more aspects of the present invention.

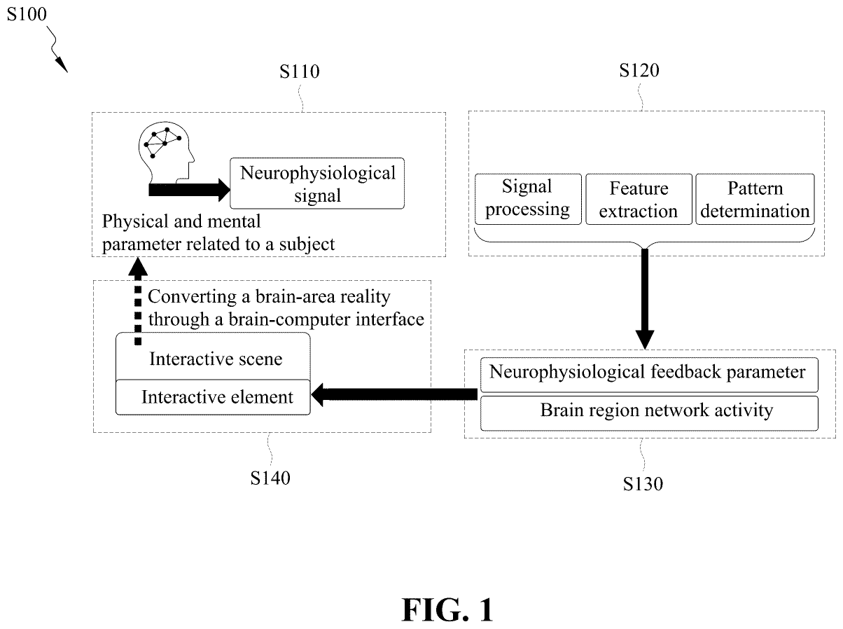

FIG. 1 is a flow chart of a method for neurofeedback training to output brain-area reality of the present invention. The method S100 for neurofeedback training to output brain-area reality of the present invention includes: transmitting a physical and mental parameter related to a subject as a neurophysiological signal (step S110); performing signal processing, feature extraction and pattern determination on the neurophysiological signal (step S120); providing a neurophysiological feedback parameter and performing a brain region network activity (step S130); and converting a brain-region reality into a brain-region reality through a brain-computer interface to present an interactive scene and an interactive element for the subject to perform a brain/brain region (an Electroencephalography (EGG) brain waves and/or brain network) training (step S140). In some embodiments, the physical and mental parameters are collected through a brainwave collection device 100. In some embodiments, the physical and mental parameters are receiving scalp EEG signals from one or more channel.

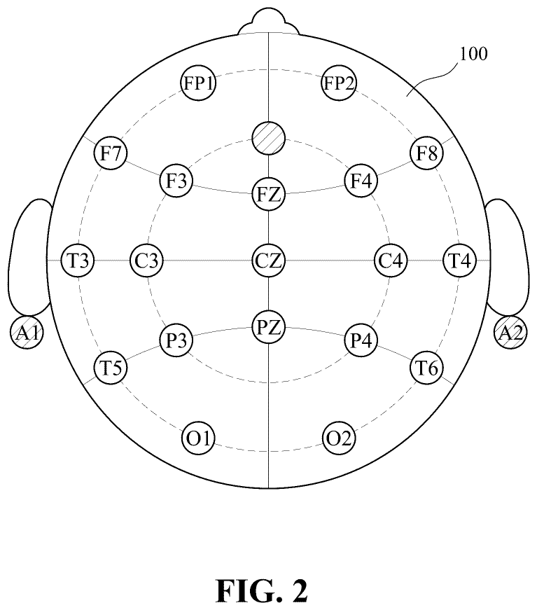

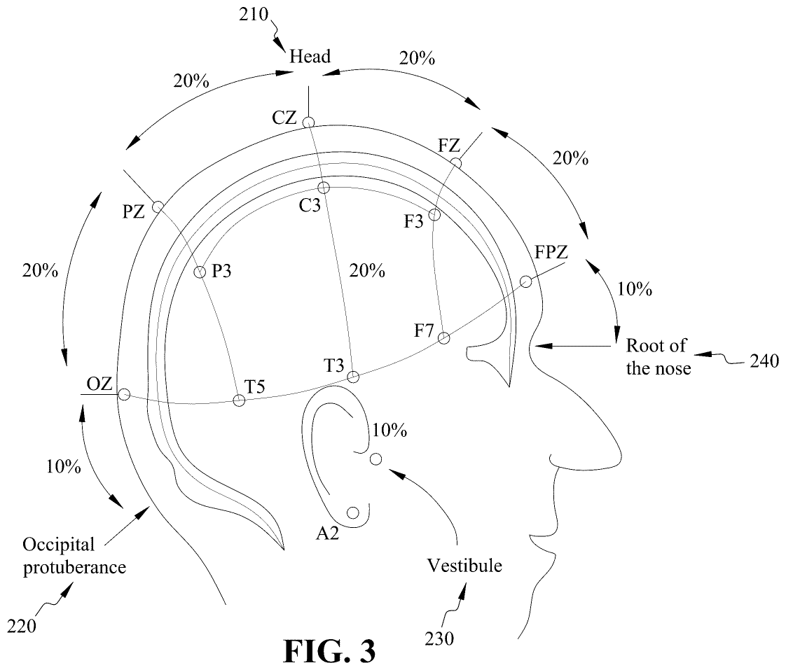

FIG. 2 is a schematic diagram of a brainwave collection device used in the method for neurofeedback training to output brain-area reality according to the present invention. FIG. 3 is a schematic side view of the brainwave collection device used in the method for neurofeedback training to output brain-area reality according to the present invention. Please refer to FIGS. 2 and 3, the brainwave collection device 100 used in the method S100 for neurofeedback training to output brain-area reality of the present invention can be an EEG Cap or a Heart Rate Variability Cap (HRV Cap). FIGS. 2 and 3 use an EEG Cap as an example for illustration, but are not limited thereto.

Please refer to FIGS. 2 and 3, the home brainwave collection device 100 is worn in contact with the subject's head 210, occipital protuberance 220, vestibule 230 and the root of the nose 240, and the home brainwave collection device 100 includes electrodes C3, C4, P3, P4, O1, O2, FP1, FP2, FZ, CZ, PZ, T3, T4, T5, T6, F3, F4, F7, F8 and ear electrodes A1 and A2, that is, the brain activity areas are positioned through the combination of brainwave sites and brainwave patterns of the 19 channels of the above 19 electrodes.

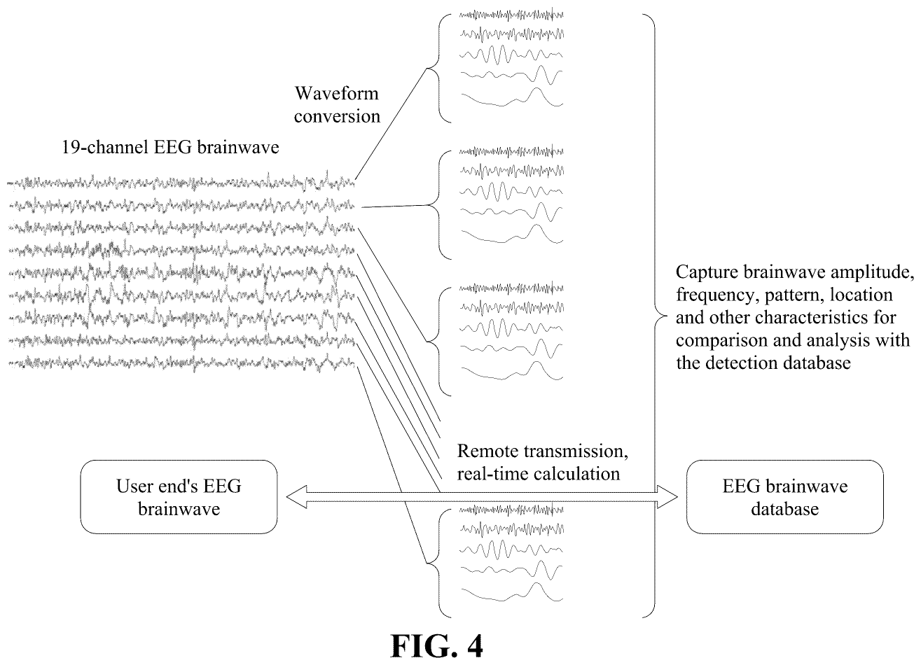

FIG. 4 is a schematic diagram of brainwave feature analysis of the method for neurofeedback training to output brain-area reality according to the present invention. In some embodiments, brain activity areas are positioned based on the combination of 19-channel brainwave sites and brainwave patterns of the home brainwave collection device used above. Therefore, the biological data may be a 19-channel EGG (Electroencephalography) brainwave data. Therefore, it is recommended that the training parameters mainly use the 19-channel brainwave data, convert it into a standard score according to the calculation, and then present an order list according to the deviation mean. The brainwave data may include amplitude, frequency, site and pattern characteristics, but is not limited thereto. As shown in FIG. 4, The brainwave characteristics detected through the 19 channels (that is, the 19 electrodes FP1, FP2, F3, F4, F7, F8, FZ, T3, C3, CZ, C4, T4, T5, P3, PZ, P4, T6, O1, O2 in FIGS. 2 and 3) of the home brainwave collection device 100 include four characteristic parameters: vibration, frequency, brainwave site (sites of 19 electrodes FP1, FP2, F3, F4, F7, F8, FZ, T3, C3, CZ, C4, T4, T5, P3, PZ, P4, T6, O1, O2), and amplitude, frequency, shape, and position of the brainwave pattern. The four characteristic parameters constitute the brainwave database of different ethnic groups through. The sites of the 19 channels are basically positioning to predict brain activity areas backwards through brainwave characteristics, which can be used as parameters for the above comparison and training. In this embodiment, the brainwaves collected by the home brainwave collection device 100 may be compared with the brainwave patterns to obtain a basic score. As shown in FIG. 4, after comparison and analysis with the brainwave database 400, a benchmark point for the index score may be generated. This benchmark point is also the difference compared to the norm, in similar groups (same age, same education level, same gender, etc.).

For example, if the brainwave collected by a subject through the home brainwave collection device 100 is converted into a score of X, but the ideal score of the subject compared with the database should be Y, then during the neurofeedback training process, the goal is to reduce the difference between X and Y, and the subject will receive feedback messages when the difference is reduced to a certain ratio. After the subject accepts the feedback message, he or she can perform another brainwave pattern comparison. At this time, the brainwaves collected by the home brainwave collection device 100 can be converted into a new benchmark score X′. This X′ will also be compared with the database, and the new neurofeedback training goal is to shorten the difference between X′ and Y. Neurofeedback training is much like muscle training for the brain. If you want to exercise a certain muscle (biceps of the hand, six-pack muscles of the abdomen, thigh muscles of the legs, etc.), the muscle endurance before exercise is X, but the goal is to obtain Y strength, then you will gradually train specific muscle groups until X-Y gets closer and closer. For example, if you want to be able to lift a 30 kg (Y) dumbbell, but currently the user end can only lift 10 kg (X), if the user end can lift 15 kg, then feedback will be given (X-Y is shortened by a certain percentage). After exercising for a period of time and reassessing, the user end can lift a 20 kg (X′) dumbbell. At this time, the user end may need to lift a 25 kg dumbbell (X′-Y is shortened by a certain proportion) to get feedback. For example, if a subject with inattention wants to improve his concentration through brain training, he can analyze the collected brainwaves. If it is found that the frontal lobe area of the brain is overactivated compared with the norm, feedback can be used to gradually reduce the difference between X and Y.

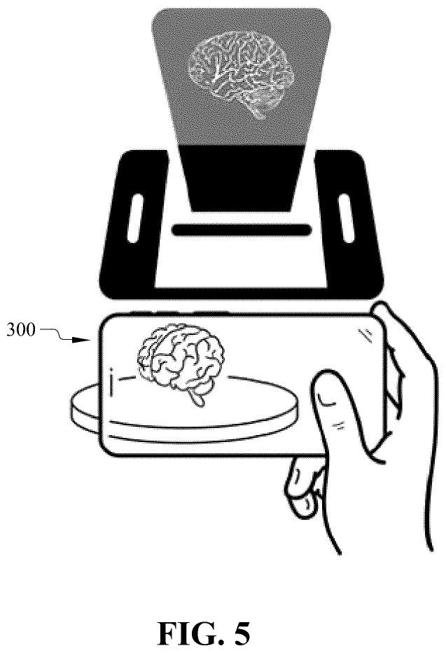

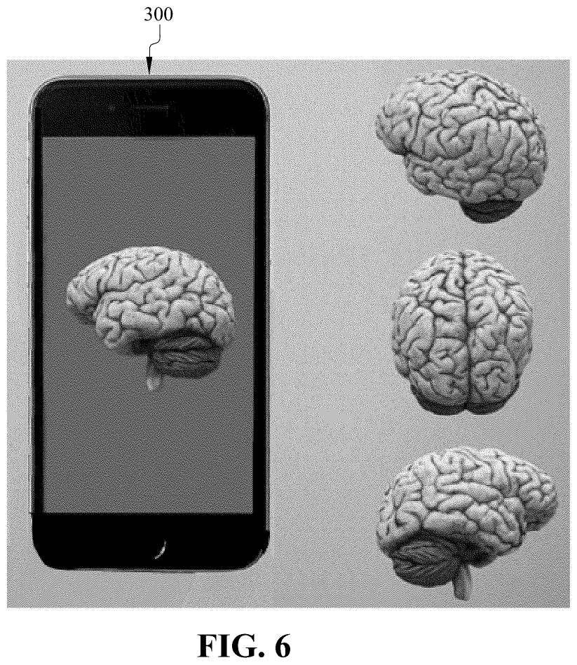

FIG. 5 is a schematic diagram of the brain reality interaction scene of the method for neurofeedback training to output brain-area reality according to the present invention. FIG. 6 is a schematic diagram of the method for neurofeedback training to output brain-area reality according to the present invention, which is implemented by the brain through augmented reality. In some embodiments, the brain-computer interface 300 is a mobile communication device, a portable device, other related electronic vehicles, or a computer. Preferably, the mobile communication device can be a smart phone, but it is not limited thereto. The smartphone has an application including the following but not limited to: web-based applications, mobile applications on smart devices, virtual reality, or video games. The portable device captures images of objects near the user and the user's location through video recording devices and network positioning. To obtain actual information, taking the present invention as an example, the image may be an individual's head, reports, teaching instructions and other related interfaces. Through digital imaging technology, image data and neurofeedback sensors are systematically superimposed. The user uses a portable device to capture the environment characteristics, and then uses the browser engine, also known as the page rendering engine, to superimpose the recognized screen and the database, and then output result. The output results can be used for report presentation, neurophysiological feedback training, brain optimization training, operation teaching, etc., including but not limited to the above functions.

In some embodiments, the brain region reality is implemented by one of augmented reality, virtual reality, mixed reality, and extended reality. Taking the example shown in FIG. 6 as an example, the present invention uses “augmented reality” to display it through the display screen of the mobile phone (brain-computer interface 300). The present invention is displayed in “augmented reality” through the display screen of the mobile phone (i.e., the aforementioned brain-computer interface 300). Brain activation or inhibition areas can be presented in 2D or 3D. Users can instantly obtain brain activity or brain area connection strength, correlation or time phase through rotation and adjustment of the portable interface. If brain optimization or neurophysiological feedback training is used, the picture will be presented as real-time dynamics. Users can obtain the current physiological signal activity status through augmented reality, mixed reality, extended reality or mixed reality to reflect actual feedback. This feedback method combines the individual's real state with simulated information, and combines sensory information such as vision, hearing, taste, smell or touch that is difficult to reflect in a certain time and space in the original actual situation, through the superposition of computing technology, image recognition and page rendering engines, this kind of superposition is a simulated superposition, so that individuals can truly feel the specific feedback.

In summary, the method for neurofeedback training to output brain-area reality of the present invention is a training brain-area reality APP. It transmits the relevant physical and mental parameters of the subject as neurophysiological signals, and performs signal processing, feature extraction and pattern determination to determine the neurophysiological feedback parameters and brain regional network activities through the brain-computer interface 300. It is transformed into a real-life environment to present interactive scenes and interactive elements for users to perform brain (area) training. In this way, the subject's brain area training status can be known in real time and the subject can understand the state of his own brain area through visual means, so as to facilitate the communication between the subject (or his family or related persons) and professionals (such as doctors). communication between.

1. A method for neurofeedback training to output brain-area reality, comprising:
transmitting a physical and mental parameter related to a subject as a neurophysiological signal;
performing signal processing, feature extraction and pattern determination on the neurophysiological signal;
providing a neurophysiological feedback parameter and performing a brain region network activity; and
converting a brain-area reality through a brain-computer interface to present an interactive scene and an interactive element for the subject to perform an Electroencephalography (EGG) brain waves and/or brain network training.

2. The method according to claim 1, wherein the brain-area reality is realized by one of augmented reality, virtual reality, mixed reality and extended reality.

3. The method according to claim 1, wherein the physical and mental parameters are collected through a brain wave collection device.

4. The method according to claim 3, wherein the physical and mental parameters are receiving scalp EEG signals from one or more channel.

5. The method according to claim 4, wherein the brainwave data includes amplitude, frequency, location and pattern characteristics.

6. The method according to claim 1, wherein the brain-computer interface is a mobile communication device or a computer.

7. The method according to claim 6, wherein the mobile communication device is a smartphone with an application including web-based applications, mobile applications, virtual reality, or video games.
